(19) United States
(12) Patent Application Publication
(10) Pub. No.: US 2013/0330126 A1
(43) Pub. Date: Dec. 12, 2013

(54) Connecting Element

(71) Applicant: DELAWARE CAPITAL FORMATION, INC., Wilmington, DE (US)

(72) Inventor: Detlev ULLE, Ostheim (DE)

(73) Assignee: DELAWARE CAPITAL FORMATION, INC., Wilmington, DE (US)

(21) Appl. No.: 13/707,794

(22) Filed: Dec. 7, 2012

(30) Foreign Application Priority Data
Jun. 8, 2012 (DE) 202012102102.1

(51) Int. Cl. B25J 19/00

(52) U.S. Cl. CPC B25J 19/00
USPC 403/404

(57) ABSTRACT

A connecting element has a base (1) with a first interface (2), to connect to a robot, and a plurality of second interfaces (3), to connect to clamping frame elements. The base (1) with its interfaces (2, 3) is formed from a fibre-plastic composite material.

### CROSS-REFERENCE TO RELATED APPLICATION

This application claims the benefit and priority of German Patent Application No. 20 2012 102 102.1, filed Jun. 8, 2012. The entire disclosure of the above application is incorporated herein by reference.

### FIELD

The disclosure relates to a connecting element and, more particularly, to a connecting element that includes a base with first and second interfaces formed from a fibre-plastic composite material.

### BACKGROUND

A connecting element is produced and marketed by the applicant as a component in the gripper product range with the brand name “SpiderGrip”. This connecting element includes a base with a first interface to connect to a robot. It has a plurality of second interfaces to connect with clamping frame elements. In the automotive industry, for example, the connecting element serves in the construction of production lines, where robots are provided with arms that include so-called clamping frames with diverse clamping devices. Thus, it is possible with such clamping frames, for example, to position body parts adjacent one another to perform joining processes (welding process) with pinpoint accuracy.

### SUMMARY

It is an object of the disclosure to improve a connecting element of the cited type. In particular, the connecting element is developed to provide even higher production rates.

This object is achieved by a connecting element of the cited type that comprises a base with a first interface to connect with a robot and a plurality of second interfaces to connect to frame elements. In accordance with the disclosure, the base, with its interfaces, is formed from a fibre-plastic composite material.

In the present disclosure, the base, previously formed from aluminium, is now replaced by a base of a fibre-plastic composite material. A carbon fibre-reinforced plastic is performed. The fibre reinforced connector has at least the same level of stability. Thus, the connector provides a significant weight reduction for the body and its interfaces. This, in turn, has the consequence that the whole clamping frame structure can be moved significantly faster by the robot by virtue of the reduced inertial forces.

Other advantageous further developments of the connecting element ensue from a reading of the specification, drawings and appended claims.

In what follows, the connecting element is explained in more detail with the aid of the representational drawing of a preferred example of embodiment.

Further areas of applicability will become apparent from the description. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective top plan view of a connecting element; and

FIG. 2 is a perspective plan view of the underside of the connecting element in accordance with FIG. 1.

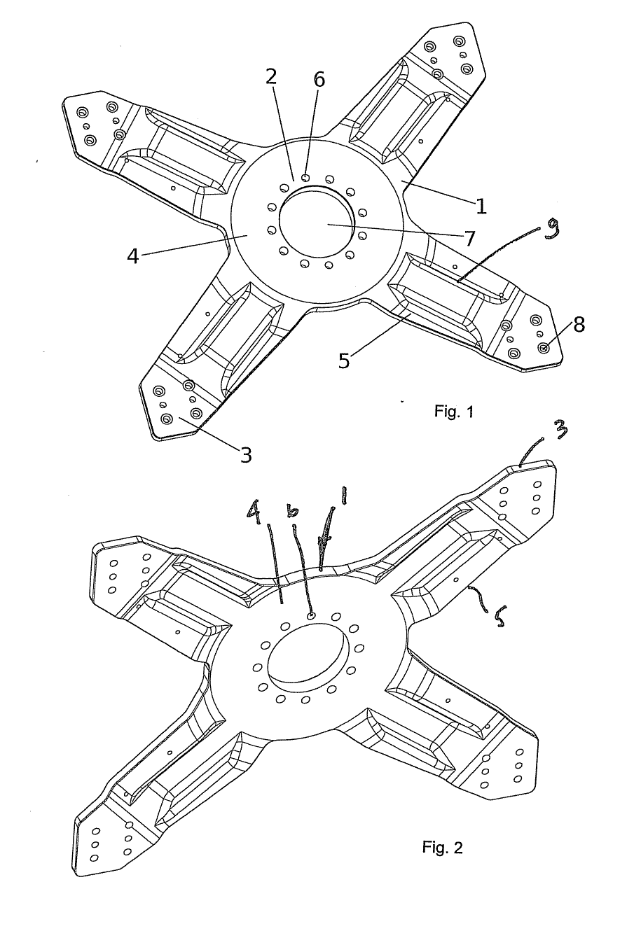

### DETAILED DESCRIPTION

The connecting element represented in the figures includes a base 1 with a first interface 2 to connect with a robot. A plurality of second interfaces 3 connect to clamping frame elements. Here “clamping frame elements” are understood to mean, for example, bar- or tube-shaped frame parts with appropriate connecting clamps on which a multiplicity of clamping devices are typically arranged.

The connecting element base 1, with its interfaces 2, 3, is formed from a fibre-plastic composite material. Preferably, the base 1 is formed from a carbon fibre-reinforced plastic. The fibre-reinforced plastic material provides a significant weight reduction for the connecting element. Thus, it is possible that the frame elements may be moved significantly faster by virtue of the reduced inertial forces. Expressed numerically: if a connecting element manufactured from aluminium weighed 14 kg, then the connecting element of the fibre-plastic composite material would weigh just 4 kg, corresponding to a weight saving of more than 70%.

As can be seen from the figures, the base 1 is designed in the shape of a star. A central element 4 includes the first interface 2. A plurality of arm elements 5 extend from the central element 4 and include the second interfaces 3. Here the second interfaces 3 are arranged at the ends of the arm elements 5. The second interfaces 3 are remote from the central element 4.

Preferably, the base 1 has one first interface 2, four arm elements 5, with a total of four second interfaces 3. Each opposing pair of arm elements 5 are arranged running parallel to one another, as seen in their main direction of extent.

The regions 9 of the base 1 arranged between the first interface 2 and the second interfaces 3 are designed in the shape of ribs to increase the stability of the connecting element. Here “in the shape of ribs” is understood to mean that these regions 9 are not designed as flat plates but rather as three-dimensionally arched connecting regions that are correspondingly stiff in bending.

The connecting element is comprised completely of the fibre-plastic composite material. The base is formed in its entirety from a homogeneous material. It includes fibres in the first part and plastic connecting the fibres in the second part. Typically, a resin, such as phenol resin, is used as the second part.

As can be seen from the figures, the first interface 2 is centrally arranged, in particular concentrically, on the base 1. The first interface is designed as a flat plate. It has a circular disk shaped with holes 6. The holes 6 are arranged on the plate and are distributed around a circle. A passage opening 7 is arranged in the center of the first interface 2 on the base 1. The holes 6 are arranged and distributed around a circle surrounding a passage opening 7. The passage opening 7 serves as a centering device.

The second interfaces 3 are likewise designed as flat plates with holes 8. The flat plate of the first interface 2 is arranged to run parallel to the flat plates of the second interfaces 3. The connecting element has an overall approximately plate-shaped configuration. However, as can be seen from the figures, the first interface 2 is preferably arranged in a plane other than that of the second interfaces 3.

Finally, the holes 6, 8, as can be seen, serve to provide a connection to the robot or to the clamping frame. The holes 6, 8 are designed as passage holes and/or threaded holes.

The description of the disclosure is merely exemplary in nature and thus, variations that do not depart from the gist of the disclosure are intended to be within the scope of the disclosure. Such variations are not to be regarded as a departure from the spirit and scope of the disclosure.

What is claimed:

1. A connecting element comprising:
a base with a first interface to connect with a robot and a plurality of second interfaces to connect to frame elements; and
the base, with its interfaces, is formed from a fibre-plastic composite material.

2. The connecting element in accordance with claim 1, further comprising a carbon fibre-reinforced plastic is provided as the fibre-plastic composite material.

3. The connecting element in accordance with claim 1, wherein the base has an overall star shape.

4. The connecting element in accordance with claim 3, wherein the star-shaped base includes a central element with the first interface and a plurality of arm elements, each arm with the second interface.

5. The connecting element in accordance with claim 4, wherein the second interfaces are arranged at the ends of each arm element and are remote from the central element.

6. The connecting element in accordance with claim 1, wherein the base has one first interface, four arm elements, each arm element with a second interface for a total of four second interfaces.

7. The connecting element in accordance with claim 6, wherein each opposing pair of arm elements are arranged to run parallel to one another, as seen in their main direction of extent.

8. The connecting element in accordance with claim 1, further comprising regions of the base, arranged between the first interface and the second interfaces, are designed in the shape of ribs.

9. The connecting element in accordance with claim 1, wherein the first interface is arranged centrally and concentrically on the base.

10. The connecting element in accordance with claim 1, wherein the first interface is designed as a flat plate including holes.

11. The connecting element in accordance with claim 10, wherein the flat plate is designed as a circular disc and the holes are arranged and distributed around a circle.

12. The connecting element in accordance with claim 11, wherein a passage opening is arranged on the plate in the center of the holes that are arranged and distributed around a circle.

13. The connecting element in accordance with claim 1, wherein the second interfaces are designed as flat plates with holes.

14. The connecting element in accordance with claim 10, wherein the flat plate of the first interface is arranged running parallel to flat plates of the second interfaces that include holes.

15. The connecting element in accordance with claim 14, wherein the holes of the first and second interfaces are designed as passage holes and/or threaded holes.
